(19) United States
(12) Patent Application Publication
(10) Pub. No.: US 2026/0210447 A1
(43) Pub. Date: Jul. 23, 2026

(54) DUAL ACTION FLOW REVERSING VALVE WITH BI-STABLE STATE

(71) Applicant: Neoperl GmbH, Müllheim (DE)

(72) Inventor: Matthias Hauth, Muggenbrunn (DE)

(73) Assignee: Neoperl GmbH, Müllheim (DE)

(21) Appl. No.: 19/140,590

(22) PCT Filed: Dec. 22, 2023
(86) PCT No.: PCT/EP2023/087649

§ 371 Date: Jun. 18, 2025

Related U.S. Application Data
(60) Provisional application No. 63/435,348, filed on Dec. 27, 2022.

(51) Int. Cl. F16K 11/044; F16K 15/06; F16K 47/00

(52) U.S. Cl. CPC F16K 11/044; F16K 15/066; F16K 47/0111

(57) ABSTRACT

A valve arrangement that is configured to passively switch between first and second operational modes. The valve arrangement includes first and second valve bodies that act against respective first and second valve seats of respective first and second valve seat inserts. The valve bodies are connected by a valve stem such that, in a first operational mode, movement of the first valve body to the closed position moves the second valve body to the open position, and in a second operational mode, upon a force of fluid acting on the first valve body overcoming a closing force of a resilient element and any pressure force, the first valve body moves to the open position while simultaneously moving the second valve body to the closed position. To enhance functionality and hold the valve in a bi-stable position, first (30) and second sleeve-shaped walls are located at the respective valve seats.

### TECHNICAL FIELD

The present invention relates to valves, and more specifically to a valve arrangement used to reverse or change a flow based on a pressure differential acting on the valve.

### BACKGROUND

The publication CN 215 831 202 U discloses an anti-backflow drainage control mechanism which comprises a shell internally provided with a water passing cavity, the shell is further provided with a water inlet, a water outlet and a drainage port, and a valve element and an elastic piece are arranged in the water passing cavity.

The publication CN 217 153 105 U describes a three-way check valve which comprises a valve body which is provided with a first connector, a second connector and a third connector which are communicated with one another, and further comprises a valve element, an elastic piece and a seat body. The seat body is fixedly arranged in the valve body and is provided with a through hole; the valve element is movably arranged in the through hole in a penetrating mode and can open the first connector and block the second connector under the action of water pressure. And the elastic piece is propped between the valve core and the seat body so as to drive the valve core to block the first interface and open the second interface.

According to the publication US 2017/075364 A1 a shuttle valve having a cage fixed in the cross bore thereof by opposed inlet adaptors extending into opposed first and second inlets is provided. A shuttle is reciprocally located in a bore in the cage, to selectively seal one of the first or second inlets from fluid communication with the valve outlet. The shuttle may be spring biased to maintain one of the inlets in the closed position without the need to apply a pressure into an inlet of the valve.

According to the document CN 207 034 260 U, a one-way valve comprises a valve body with a hollow passage, characterized in that: the valve body comprises a first valve body with one end being provided with a liquid inlet and a second valve body connected to the first valve body; a valve core assembly is arranged in the first valve body, comprising a valve stem, a spring sleeved on the valve stem and a bottom cover; the bottom cover is embedded and installed at the other end of the first valve body; a through hole is arranged on the bottom cover to form a reflux port; one end of the spring abuts against the valve stem, and the other end abuts against the bottom cover. When one end of the valve stem is in abutment with the liquid inlet, the liquid inlet and the hollow channel of the first valve body are closed, and the reflux port is in communication with the hollow channel of the first valve body; when the other end of the valve stem is in abutment with the bottom cover, the reflux port and the hollow channel of the first valve body are closed, and the liquid inlet and the hollow channel of the first valve body are in communication; the second valve body is arranged between the liquid inlet and the reflux port.

In U.S. Pat. No. 4,941,502 A a low pressure recirculation valve for cooling a centrifugal pump is presented. The invention comprises a unitary valve casing divided into a first valve chamber and a second valve chamber, the casing having a first port for introducing fluids into said first chamber, and a second port for expelling fluids out of said second chamber, the first chamber having a recirculation port for redirecting fluids back to said centrifugal pump. A multiple piece check valve member situated between said first chamber and second chambers permits the flow of fluid from said first chamber to the second chamber and prevents the flow of fluid from said second chamber to said first chamber. A slidable valve stem coupled to said check valve member and extending through the first chamber moves the check valve member from an open to closed position. Means coupled to said valve stem biases the slidable valve stem and check valve means toward the closed position. A recirculation valve means operatively coupled to said valve stem opens and closes said recirculation port, said recirculation valve means opening when said check valve means is closed and closing when said check valve means is open.

Systems described in co-pending applications of the present assignee that are being filed on the same date as the present application and entitled “Heat Exchanger With Integrated Dual Action Flow Reversal Valve” and “Dual Action Backflush Valve Having Linked Valve Bodies”, both by inventor Stephen J. Harrison, describe a valve arrangement having linked valve bodies that can be used in various applications, including backflushing of water heaters.

It would be desirable to provide a valve for such applications that has a bi-stable switching operation and transitions between states at a desired pressure and/or flow rate.

### SUMMARY

In one aspect, the present disclosure is directed to a valve arrangement that is configured to passively switch between first and second operational modes. The valve arrangement includes first, second, and third ports, preferably in a valve housing. A first valve body is biased by a resilient element to a closed position against a first valve seat of a first seat insert which is located at or in proximity to the third port, in order to close the third port in the first operational mode. The valve arrangement further includes a second valve body that acts against a second valve seat of a second seat insert, which is located at or in proximity to the second port, and in the first operational mode, the second valve body is in an open position spaced apart from the second valve seat such that fluid is adapted to circulate from the first port to the second port. A valve stem extends axially between the second valve body and the first valve body such that, in the first operational mode, movement of the first valve body to the closed position moves the second valve body to the open position, allowing circulation of fluid between the first and second ports. In the second operational mode, upon a force of a fluid acting on the first valve body from the third port overcoming a closing force of the resilient element and any pressure force of the fluid from the first and/or second ports, the first valve body is movable to the open position while simultaneously moving the second valve body to the closed position against the second valve seat such that the fluid from the third port is adapted to circulate through the first port. A first sleeve-shaped wall, which is preferably cylindrical, is provided on or in the first seat insert that extends in the axial direction and is configured to radially surround the first valve body when the first valve body is in the closed position. A second sleeve-shaped wall, which is preferably cylindrical, is provided on or in the second seat insert that extends in the axial direction and is configured to radially surround the second valve body when the second valve body is in the closed position. In order to provide a bi-stable position of the valve bodies with minimized switching time between the first and second operational modes, the first and second valve bodies and the stem are arranged such that as the first valve body moves toward the open position, the first sleeve-shaped wall axially overlaps a portion of the first valve body until the second valve body moves to a position, prior to reaching the closed position, where it is at least partially overlapped by the second sleeve-shaped wall.

In an embodiment of the invention, the second valve body has at least one relief groove on its seat side. Thus, the seat side and the stem side of the second valve body may be in fluid communication across the second valve seat even in the closed position. This may help to prevent a large differential pressure across the second valve seat that would result in a second valve body being sucked into its seat.

In an embodiment of the invention, a damper acts on the valve stem to damps a motion that compresses the resilient element. This may help to reduce water hammer effects upon closing of the second valve seat.

In an embodiment of the invention, the damper applies a lesser damping to the valve stem in the direction of expansion of the resilient element than in the direction of compression of the resilient element. This allows a quicker opening of the second valve seat.

In an embodiment of the invention, a, for instance said, damper acting on the valve stem comprises at least one elastomeric element, e.g. at least one lip seal, and/or at least one bypassing passage, in particular bypassing groove, formed in the valve stem. The combination of bypassing passages, in particular bypassing groves, and elastomeric elements for sealing, in particular lip seals, is particularly advantageous as the element or lip will close more in situations of rapid movements or higher pressure, thereby increasing the damping.

In an embodiment of the invention, a, for instance said, damper acting on the valve stem (70) comprises at least two lip seals opposing each other. Thus, an easy way to provide a damper is described.

Additionally, upon the resilient force and any pressure force from the first and/or second port overcoming the pressure of the fluid at the third port, the valve arrangement is configured to return to the first operational mode. Here, the second valve body moves back toward the open position, the second sleeve-shaped wall axially overlaps a portion of the second valve body until the first valve body moves to a position, prior to reaching the closed position, where it is at least partially overlapped by the first sleeve-shaped wall.

With this arrangement, the sleeve-shaped walls guide fluid toward a stem side of each of the respective valve bodies when they are moving toward the closed position, enhancing switching performance and stability of the respective first or second valve bodies in the respective closed position (i.e., the valve arrangement has bi-stable closed positions of the first or second valve bodies depending on the fluid pressure at the third port in comparison to the force of the resilient element and the fluid at the first and/or second ports).

Preferably, at least one of the first or second valve bodies, and preferably both, are cup-shaped and have an axially extending wall section, preferably cylindrical, that fits inside the respective first or second sleeve-shaped wall section. Here a clearance fit is provided so that there is no additional friction force that needs to be overcome for movement of the valve bodies between the first and second operational modes.

In a further embodiment, a shield is connected to the valve housing, and more preferably the second seat insert, in proximity to the second port. The shield includes a receiving space that faces the stem side of the second valve body, and in the first operational mode, when the second valve body is in the open position, the shield surrounds a peripheral region of the second valve body. Preferably, the shield peripherally surrounds at least a portion of the axially extending wall section of the second valve body. This generally prevents fluid flow through the valve arrangement from acting on the stem side of the second valve body in the first operational mode. As the valve arrangement moves to the second operational mode, the second valve body moves axially out from the receiving space of the shield such that fluid flow through the valve arrangement can act on the stem side of the second valve body, applying a force on the second valve body to assist in moving the second valve body against the second valve seat in the second operational mode.

In a preferred embodiment, the shield defines a bottleneck for fluids flowing from the first port and/or the third port to the second port and wherein the second valve body, in its open position, is spaced apart from the bottleneck. Thus, a situation can be avoided in which the second valve body is sucked out of its receiving space due to low pressure regions created downstream of the bottleneck. For this, a preferred embodiment has a second valve body that is fully received withing the receiving space.

The shield is preferably frusto-conical shaped, and is supported by one or more fins that extend from the surrounding valve housing, or more preferably the second seat insert. The stem or a stem socket on a stem side of the second valve body to which the stem is connected extends through an opening in the shield. Preferably a stem receiving sleeve is connected to the shield, and this opening is defined through the stem receiving sleeve.

In another aspect, the second valve body preferably includes a ramp section on the second valve seat side thereof. The ramp section is preferably frusto-conical, and when the valve arrangement is in the first operational mode, the fluid flow through the valve arrangement acts on the ramp section to apply an additional force on the second valve body in an axial direction toward the first valve body that acts in addition to the resilient force to keep the first valve body pressed in the closed position against the first valve seat in the first operational mode. To the extent that the shield is utilized, this also acts to hold the second valve body in a position where the shield peripherally surrounds at least a portion of the axially extending wall section of the second valve body. This helps to prevent unintentional movement of the second valve body toward the second valve seat in the first operational mode due to the fluid flow between the first and second ports. Preferably, with one or more of these features, the valve arrangement is maintained in the first operational mode with the first valve body in the closed position against the first valve seat for flows of 6 liters per minute or greater. The design can be adjusted based on the resilient force of the spring, the size of the valve bodies, the shield shape and position to account for different flow rates depending on the particular application.

In another aspect, the valve stem is preferably formed to provide an adjustable length in use to compensate for tolerances. Here, the valve stem includes at least one projection at each of the first and second axial ends. This can be an annular projection or one or more peripherally spaced apart projections at each axial end. The first and second valve bodies each include a respective first and second socket connected to the respective stem side of the valve bodies that is configured to receive the respective first or second axial end of the stem. The first and second sockets each include an internal groove in which the respective at least one projection is received, preferably with a snap fit.

At least one, and preferably both of the internal grooves have a longer axial dimension than an axial width of the at least one projection received therein such that an axial compensating movement is provided. This axial compensating movement is equal to the difference between the axial dimension of the groove and the projection width, and is two times this amount if the axial compensation is provided at the connection between the stem and both of the first and second valve bodies.

Preferably, both axial ends of the stem are tapered in order to allow for “blind” installation of valve arrangement into a valve housing. For example, the first valve body can be assembled with the resilient element and retained in the first seat insert, and the first axial end of the valve stem can be inserted with a snap fit into the first socket on the stem side of the first valve body. This first assembly can be inserted stem first into the third port of the valve housing. The second valve body that is assembled with the second seat insert and the shield can be inserted into the second port of the valve housing, and the tapered second end of the stem is received in the second socket on the second valve body and is then connected with the snap fit. The first and second seat inserts can be retained in the valve housing through various means, such as a retainer ring and groove, a washer or other projection that extends over an end of the respective third and second ports as part of the assembly or during connection of further piping or fittings, against a shoulder in the valve housing, a press fit, or various other means that will be understood by those skilled in the art from the present disclosure. The first and second seat inserts may also include seals, either integral or separately retained, on a periphery thereof that contact the walls of the third and second ports when they are installed.

For certain applications where minor leakage through the first or second valve bodies when they are in the respective closed positions against the respective first and second valve seats is acceptable to the operation of the valve arrangement, no separate seals are provided at these locations.

Preferably all of the components of the valve arrangement are made of a polymeric material, with the possible exception of the resilient element that can be a metallic spring. Preferably these polymeric components can be injection molded.

This valve arrangement allows for totally passive operation between the first and second operational positions depending on the fluid pressure at the third port in comparison to the force of the resilient element and the pressure at the first and/or second ports.

The resilient element is a spring, preferably a metallic coil spring.

Preferably, the second and third ports are axially aligned.

This arrangement is particularly useful for a flow-reversing or backflow valve that is used with or integrated in a heat exchanger, and the heat exchanger body itself can form the valve housing.

The features noted above can be used alone or in various combination to provide a desired level of functionality.

For example, in another embodiment, the valve arrangement that is configured to passively switch between first and second operational modes, also has the first, second, and third ports, preferably in a valve housing, and includes a first valve body biased by a resilient element to a closed position against a first valve seat of a first seat insert which is located at or in proximity to the third port, in order to close the third port in the first operational mode, as well as a second valve body that acts against a second valve seat of a second seat insert, which is located at or in proximity to the second port, and in the first operational mode, the second valve body is in an open position spaced apart from the second valve seat such that fluid is adapted to circulate from the first port to the second port. A valve stem extends between the second valve body and the first valve body such that, in the first operational mode, movement of the first valve body to the closed position moves the second valve body to the open position, allowing circulation of fluid between the first and second ports, and in the second operational mode, upon a force of the fluid acting on the first valve body from the third port overcoming a closing force of the resilient element and any pressure force of the fluid from the first and/or second ports, the first valve body is movable to an open position while simultaneously moving the second valve body to a closed position against the second valve seat such that the fluid from the third port is adapted to circulate through the first port. In this embodiment, a shield is located in proximity to the second port, and the shield includes a receiving space that faces a stem side of the second valve body, and in the first operational mode. When the second valve body is in the open position, the shield surrounds a peripheral region of the second valve body.

This embodiment does not use the first and second sleeve-shaped wall sections, but could use other ones of the features noted herein.

In another embodiment, the valve arrangement that is configured to passively switch between first and second operational modes, also has the first, second, and third ports, preferably in a valve housing, and includes a first valve body biased by a resilient element to a closed position against a first valve seat of a first seat insert which is located at or in proximity to the third port, in order to close the third port in the first operational mode, as well as a second valve body that acts against a second valve seat of a second seat insert, which is located at or in proximity to the second port, and in the first operational mode, the second valve body is in an open position spaced apart from the second valve seat such that fluid is adapted to circulate from the first port to the second port. A valve stem extends between the second valve body and the first valve body such that, in the first operational mode, movement of the first valve body to the closed position moves the second valve body to the open position, allowing circulation of fluid between the first and second ports, and in the second operational mode, upon a force of the fluid acting on the first valve body from the third port overcoming a closing force of the resilient element and any pressure force of the fluid from the first and/or second ports, the first valve body is movable to an open position while simultaneously moving the second valve body to a closed position against the second valve seat such that the fluid from the third port is adapted to circulate through the first port. In this embodiment, the second valve body includes a ramp section on a second valve seat side thereof.

This embodiment also does not use the first and second sleeve-shaped wall sections, but could use other ones of the features noted herein.

### BRIEF DESCRIPTION OF THE DRAWINGS

Further advantages and characteristics of the invention will become apparent by the below description of embodiments making reference to the accompanying drawings, in which:

FIG. 1 is a cross-sectional view through a valve arrangement in accordance with the present disclosure shown in a first operating mode.

FIG. 2 is a cross-sectional view similar to FIG. 1 showing the valve arrangement according to the disclosure in a second operating mode.

FIG. 3 is a view showing the outside of the valve housing of the valve arrangement according to the disclosure, partially broken away, showing the assembly of the valve arrangement in the valve housing.

FIG. 4 is a perspective view showing only the operating portion of the valve arrangement including first and second seat inserts which include first and second valve bodies located respectively therein that are connected via a stem and can be arranged in the third and second ports, respectively, of the valve housing.

FIG. 5 is a perspective view similar to FIG. 4, partially broken away such that the internal components including the first and second valve bodies within the first and second seat inserts are shown.

FIG. 6 is a cross-sectional view taken along lines 6-6 in FIG. 4 showing the first and second valve bodies connected via the stem in the first operating mode.

FIG. 7 is a cross-sectional view similar to FIG. 6 showing the first and second valve bodies connected by the valve stem transiting from the first operating mode to the second operating mode.

FIG. 8 is a cross-sectional view similar to FIGS. 6 and 7 showing the first and second valve bodies connected by the stem in the second operating mode.

FIG. 9 is an enlarged detailed view of the second valve body within the second seat insert shown in the first operating mode with a shield covering a stem side of the second valve body, showing a force of the fluid flow acting on a seat side surface of the second valve body in order to hold the second valve body in position in the first operating mode.

FIG. 10 is a cross-sectional view similar to FIG. 6 showing the first and second valve bodies connected by the valve stem in the first operating mode with the first valve body closed against the first valve seat and the compensating connections between the stem and the valve bodies.

FIG. 11 is an enlarged detail view showing the connection of the valve stem to the second valve body with compensating play provided in the connection.

FIG. 12 is a cross sectional view of another embodiment in, wherein the second valve body is in its closed position.

FIG. 13 is a three-dimensional view of the valve stem of FIG. 12.

FIG. 14 is a cross sectional view of the embodiment of FIG. 12, wherein the second valve body is in its open position. The insert shows an enlarged view of the damper of the embodiment.

FIG. 15 is a three-dimensional view of the isolated shield of FIGS. 12 and 14.

FIG. 16 is a cut-away view along the cutting plane indicated in FIG. 14.

### DETAILED DESCRIPTION

Certain terminology is used in the following description for convenience only and is not limiting. The words “right,” “left,” “top,” and “bottom” designate directions in the drawings to which reference is made. The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof. The terms approximately or generally mean within +/−10% of a specified value unless otherwise noted, and within +/−25° of a specified angle or direction. The term “passively” in connection with the present valve arrangement means that the valve arrangement can switch between the first and second operating modes automatically based on a pressure differential between fluid at the third port versus a pressure of the fluid at the first and/or second port, without the need for an external actuator acting on the valve arrangement.

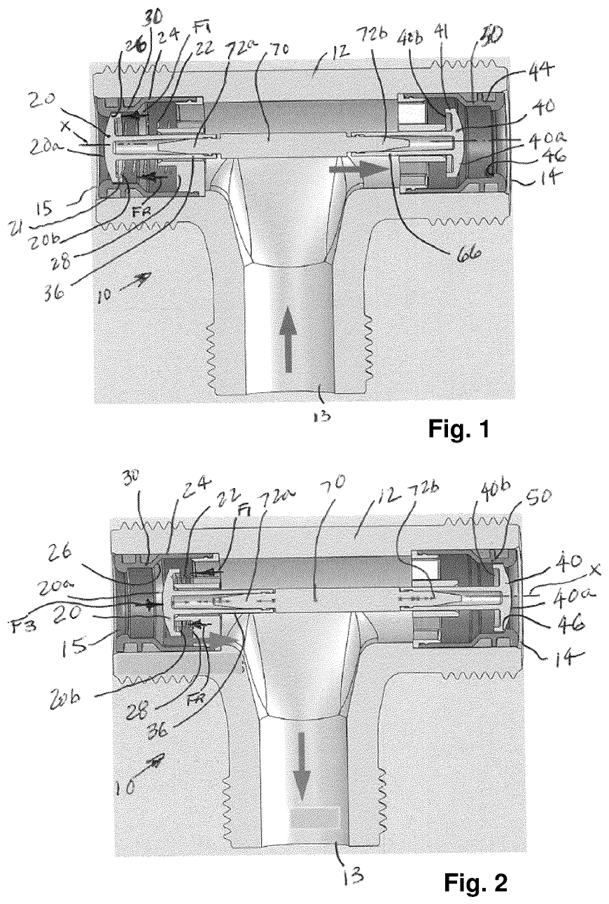

Referring to FIGS. 1 and 2, a valve arrangement 10 according to the present disclosure is generally shown. The valve arrangement 10 includes a valve housing 12 with first, second, and third ports, 13, 14, 15. The valve housing 12 can be T or Y-shaped, or can have any other desired shape with 3 ports, and can also be formed by a heat exchanger body. A first valve body 20 is provided and is biased by a resilient element 22, preferably a spring, into a closed position against a first valve seat 26 provided in a first seat insert 24 that is located at or in proximity to the third port 15. In the first operating mode, as shown in FIG. 1, the first valve body 20 is closed against the first valve seat 26 via the force of the spring, indicated by arrow FR as well as the force of any fluid flow F₁ through the first and/or second ports 13, 14 acting against a stem side 20b of the first valve body 20. The seat side 20a of the first valve body 20 is also indicated. A spring retainer 28 is also shown connected to the first seat insert 24 and supports the resilient element 22, in order to apply the force FR against the stem side 20b of the first valve body 20.

Still with reference to FIGS. 1 and 2, a second valve body 40 is shown that acts against a second valve seat 46 of a second seat insert 44, which is located at or in proximity to the second port 14. In the first operational mode, the second valve body 40 is in an opened position spaced apart from the second valve seat 46 such that fluid is adapted to circulate from the first port 13 to the second port 14, as indicated in FIG. 1. The second valve body 40 also includes a seat side 40a and a stem side 40b.

A valve stem 70 extends between the second valve body 40 and the first valve body 22 such that, in the first operational mode, shown in FIG. 1, movement of the first valve body 22 to the closed position moves the second valve body 40 to the open position, allowing circulation of fluid between the first and second ports 13, 14. In the second operational mode, shown in FIG. 2, upon a force of fluid F₃ acting on the first valve body 20 from the third port 15 overcoming a closing force FR of the resilient element 22 and any pressure force F₁ acting on the first valve body 20 and/or the second valve body 40 due to fluid flow from the first and/or second ports 13, 14, the first valve body 20 is moveable to an open position while simultaneously moving the second valve body 40 to a closed position against the second valve seat 46 such that the fluid from the third port 15 is adapted to circulate through the first port 13, as indicated by the arrows in FIG. 2.

As shown in FIGS. 1 and 2 and indicated in detail in FIGS. 5-8, a first sleeve-shaped wall 30 of the first insert 24 extends in an axial direction X and is configured to radially surround the first valve body 20 when the first valve body 20 is in the closed position, shown in FIGS. 1, 5, and 6. Preferably, the valve body 20 has a circular-shaped periphery and the first sleeve-shaped wall 30 is cylindrical.

Still with reference to FIGS. 1, 2, and 5-8, a second sleeve-shaped wall 50 of the second seat insert 44 extends in the axial direction X and is configured to radially surround the second valve body 40 when the second valve body 40 is in the closed position, as shown in FIG. 8. The second valve body 40 preferably also has a circular configuration and the second sleeve-shaped wall 50 is preferably cylindrical.

As shown in detail in FIG. 7, the first and second valve bodies 20, 40 and the valve stem 70 are arranged such that as the first valve body 20 moves toward the open position, the first sleeve-shaped wall 30 axially overlaps a portion of the first valve body 20 until the second valve body 40 moves to a position, prior to reaching the closed position, where the second valve body 40 is at least partially overlapped by the second sleeve-shaped wall 50. This arrangement promotes a bi-stable position of the valve bodies 20, 40 depending on the acting pressures F₃ and F₁ with either the first valve body 20 in the closed position or the second valve body 40 in the closed position for the first and second operational modes such that the third and second ports 15, 14 are either fully opened or fully closed, minimizing switching time. As the valve arrangement transitions to the second operating mode, as shown in FIG. 7, the fluid flow is directed primarily against the stem-side 40 of the second valve body 40 as soon as it enters the sleeve-shaped wall 50, eliminating, for the most part, the force F₁ of any fluid flow from the first port 13 acting on the seat side 40a of the second valve body 40.

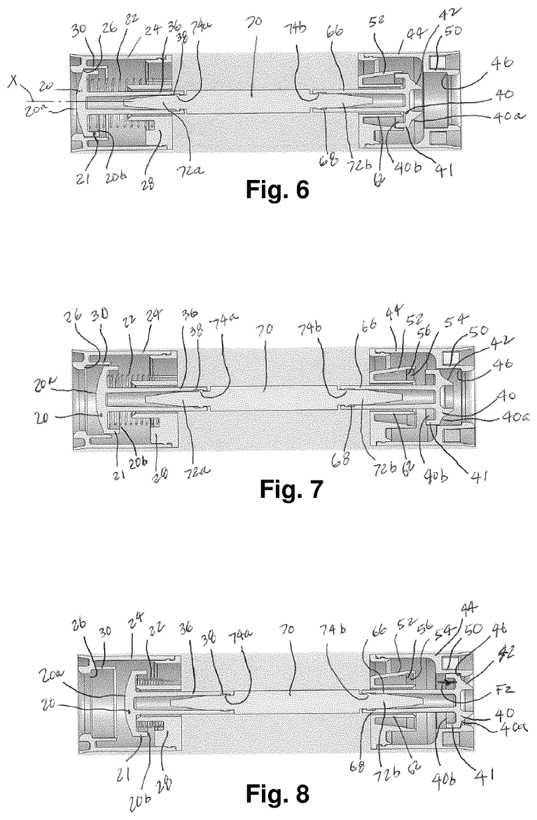

In order to switch back from the second operational mode shown in FIGS. 2 and 8 to the first operational mode shown in FIGS. 1 and 6, upon the closing force FR of the resilient element 22 and the pressure force F₁ from at least one of the first or second ports 13, 14 overcoming the force F₃ of the fluid at the third port 15, the second valve body 40 moves back toward the open position, and the second sleeve-shaped wall 50 axially overlaps a portion of the second valve body 40 until the first valve body 20 moves to a position, prior to reaching the closed position, where the first valve body 20 is at least partially overlapped by the first sleeve-shaped wall 30. Using this arrangement, the force F₁ of the fluid from the first and/or second ports 13, 14 is directed mainly against the stem side 20b of the first valve body 20 prior to the first valve body 20 reaching the closed position since the sleeve-shaped wall 30 prevents the force F₁ of fluid from the first and/or second ports 13, 14 from acting on the seat side 20a of the first valve body 20.

As show in detail in FIGS. 6-8, the first and second valve bodies 20, 40 are both cup-shaped and have an axially extending wall section 21, 41 that fits inside the respective first or second sleeve-shaped wall 30, 50 with a clearance fit. Here, the clearance fit is 0.1 mm-0.8 mm, but could vary depending upon the particular application and the size of the components. This clearance fit reduces or eliminates any potential friction as the respective valve bodies 20, 40, transition to the respective closed positions.

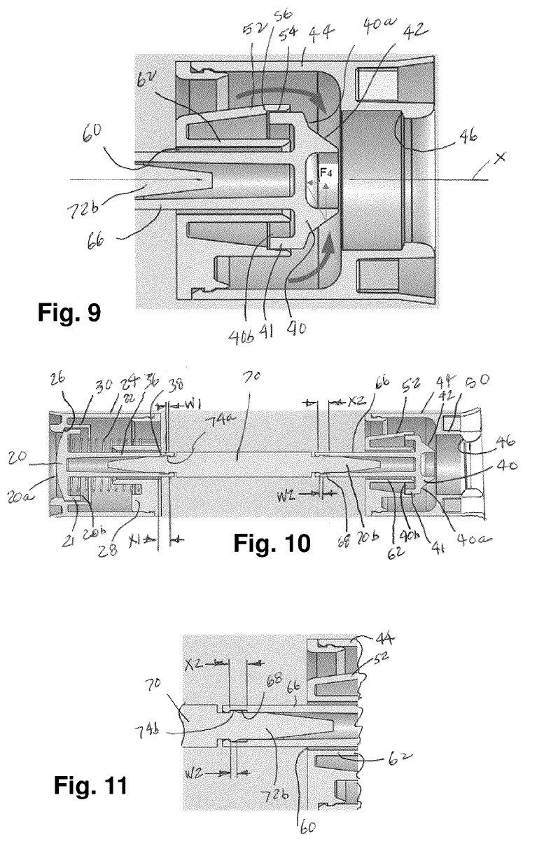

Referring now to FIGS. 5-9, preferably a shield 52 is connected to the valve housing 12 and more preferably to the second seat insert 44 in proximity to the second port 14. The shield 52 includes a receiving space 54, preferably defined as a shoulder 56, and faces the stem side 40b of the second valve body 40. In the first operational mode, shown in FIGS. 6 and 9, when the second valve body 40 is in the open position, the shield 52 surrounds a peripheral region of the second valve body 40 preventing fluid flow directly against the stem side 40b of the second valve body 40. In the preferred arrangement, the shield 52 is formed as a separate part that is connected to the second seat insert 44, preferably with a snap fit. As shown, the cup-shaped second valve body 40 preferably has the axial extending wall section 41 that is peripherally surrounded by the shield 52 in the first operating mode. With this arrangement, fluid flows between the first port 13 and the second port 14 are limited from acting on the stem side 40b of the second valve body 40 thus maintaining the stable position of the first valve body 20 closed against the first seat 26. This provides stability for maintaining the valve bodies 20, 40 in the first operating mode for fluid flows of six liters/minute or greater from the first port 13 to the second port 14. Depending upon the particular application, the specific flow rate can vary; however, the objective of providing a bi-stable position of the valve arrangement 10 is achieved using the sleeve.

As shown in FIGS. 7 and 8, in the second operational mode, the second valve body 40 moves axially out from the receiving space 54 of the shield 52 such that the fluid flow through the valve arrangement 10 acts on stem side 40b of the second valve body 40 and applies a force F₂ (indicated in FIG. 8) on the second valve body 40 to assist in moving the second valve body 40 against the second valve seat 46.

In the preferred arrangement, the shield 52 has a frusto-conical shape with the narrower portion facing the stem 70, and is supported by one or more fins 58 that extend from at least one of the valve housing 12 or the second seat insert 44.

As shown in FIGS. 6-9, the shield 52 preferably includes a central opening 60, and the stem 70 and/or a second socket 66 of the second valve body 40 that receives the stem 70 extends through the opening 60. Further, as shown in detail in FIG. 9, the shield 52 preferably includes a stem receiving sleeve 62. The opening 60 is defined through the stem receiving sleeve 62. Here, a clearance fit is preferably also provided between the stem 70 or the second socket 66 and the opening 60 to reduce potential water flow to the stem side 40b of the second valve body 40 in the first operational mode, shown in FIG. 6. The clearance fit is preferably 0.02-1.0 mm. However, the size could vary depending upon the particular application.

It is noted that the shield 52 can be used in the valve arrangement 10 without the use of the first and second sleeve-shaped walls 30, 50, depending on the functionality required for the particular application.

Referring again to FIG. 9, the second valve body 40 preferably further includes a ramp section 42 on the valve seat side 40b thereof. The ramp section 42 is preferably frusto-conical with the narrower end facing the second valve seat 46, and when the valve arrangement 10 is in the first operational mode, a force F₄ of the fluid flow through the valve arrangement 10 acts on the ramp section 42 to apply an additional force in the axial direction X toward the first valve body 20. This acts in addition to the resilient force FR of the resilient element 22 and the force F₁ on the first valve body 20 to keep the first valve body 20 pressed in the closed position against the first valve seat 26. This further maintains the second valve body located in the receiving space 54 of the shield 52 and promotes the bi-stable positions that are maintained by the valve bodies 20, 40 in the first and second operational modes with limited switching time between these positions.

It is noted that the ramp section 42 can also be used in the valve arrangement 10 without the use of the first and second sleeve-shaped walls 30, 50, and/or the shield 52 depending on the functionality required for the particular application. Referring now to FIGS. 10 and 11, the valve stem 70 includes at least one projection 74a, 74b at each of the first and second axial ends 72a, 72b. The first and second valve bodies 20, 40 each include a respective first and second socket 36, 66 connected to the respective stem side 20b, 40b thereof. The first and second sockets 36, 66 are configured to receive the respective first or second axial ends 72a, 72b of the stem 70. These first and second sockets 36, 66 also each include an internal groove 38, 68 in which the respective at least one projection 74a, 74b is received with a snap fit.

The at least one projection 74a, 74b at each of the first and second axial ends 72a, 72b of the valve stem 70 can include one or more circumferentially separated protrusions or a single annular protrusion.

As shown in detail in FIG. 11, with respect to the second axial end 72b of the stem 70, and equally applicable to the first axially end 72a as indicated in FIG. 10, at least one of the internal grooves 38, 68 has a longer axial dimension X1, X2 than an axial width W1, W2 of the at least one projection 74, 74b received therein. This allows for axial compensating movement of one or both of the valve bodies 20, 40 relative to the stem 70. This can allow for tolerance differences for installation in different valve housings 12 and ensures that both closing positions can be reached.

As shown in detail in FIGS. 10 and 11, the first and second axial end 72a, 72b of the valve stem are preferably tapered. This allows for easier alignment and assembly of the valve stem 70 with respective first and second valve bodies 20, 40.

In another aspect, a method of assembling a valve arrangement 10 is also provided. The method includes forming a first sub-assembly by assembling the first valve body 20 with the resilient element 22 in the first seat insert 24 that includes the first valve seat 26, and inserting a first axial end 72a of the valve stem 70 with a snap fit into the first socket 36 on the stem side 20b of the first valve body 20. This first sub-assembly is then inserted stem first into the port 15 of the valve housing 12.

The method further includes forming a second sub-assembly by assembling the second valve body 40 with the second seat insert 44 that includes the second valve seat 46 and a shield 52 that partially surrounds the second valve body 40 in the open position of the second valve body 40. This second sub-assembly is then inserted into the second port 14 of the valve housing 12 with the second axial end 72b of the stem 70 being received in the second socket 66 on the second valve body 40, with the stem 70 and/or the sleeve socket 66 extending through the opening 60 in the shield 52. The second axial end 72a of the stem 72 is connected via a snap fit with the second socket 66, such that the valve arrangement is connected in the valve housing 12 with the valve stem 70 extending between the second valve body 40 and the first valve body 40. This allows the valve arrangement 10 to operate in the first and second operational modes as described above.

In certain applications, the first and second valve bodies 20, 40 do not need further seals as minor leakage can be allowed, particularly in reverse flow applications used in connection with heat exchangers. Here, the valve housing 12 can be an integral part of a heat exchanger.

Preferably, the valve bodies 20, 40, the seat inserts 24, 44, as well as the stem 70 are formed as injection-molded polymeric parts. However, these can be formed by other means, such as machining or casting.

Additionally, in a preferred embodiment the second and third ports 14, 15, are axially aligned, and the first port 13 extends generally normal thereto such that the ports are connected in a “T” configuration in the valve housing 12.

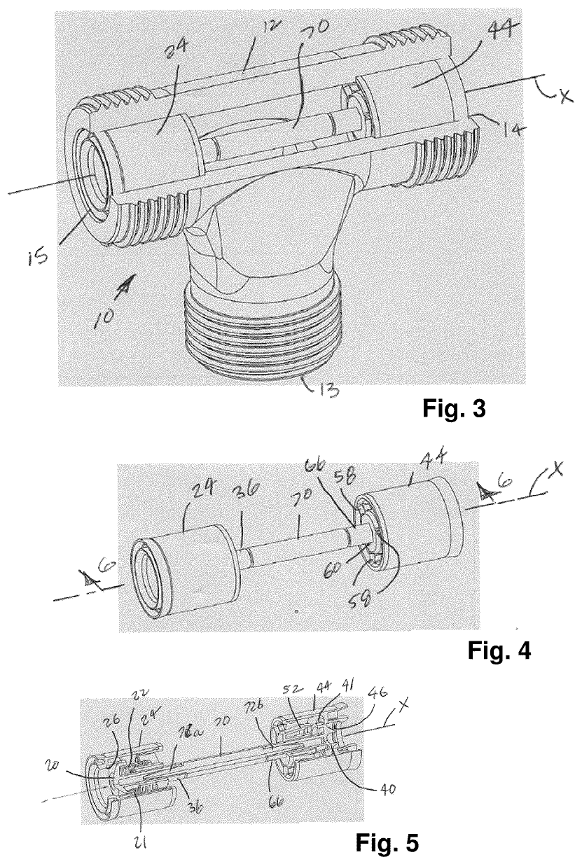

The first and second seat inserts 24, 44, can be held against a shoulder within the valve housing 12, for example, as illustrated in FIGS. 1-3, and the seat inserts 24, 44 may have lip seals (illustrated but not labeled) formed integrally therewith that contact an inside of the valve housing 12 or separate seals may be applied to seal the seat inserts 24, 44 inside the valve housing 12. Snap rings, retainers, or external washers or couplings applied at the ends of the second and third ports 14, 15 can be used to retain the seat inserts 24, 44 respectively in position within the valve housing 12. However, other types of retaining arrangements can be used as well.

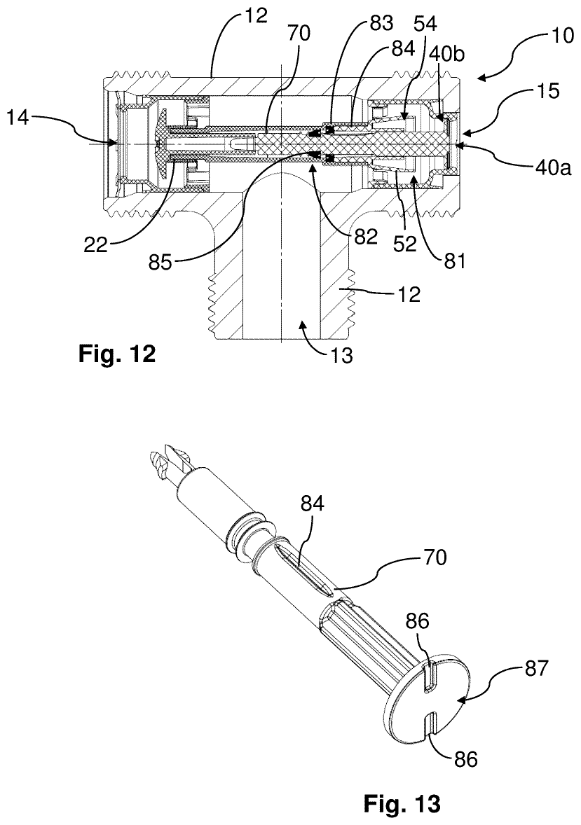

FIGS. 12 to 14 show a further embodiment of the invention. Components that are functionally similar or identical to the previous embodiments carry identical reference numerals. The explanations given to FIGS. 1 to 11 can thus be read on FIGS. 12 to 14.

The embodiment of FIGS. 12 to 14 comprises a damper 82 that acts onto the valve stem 70. More precisely, the damper 82 damps an compression of the resilient element 22.

This is achieved by a lip seal 83 cooperating with a bypassing groove 84. Thus, upon compression of the resilient element 22, fluid between the lip seals 83 and 85 will be forced through the bypassing groove 84 as the lip seals 83, 85 face each other.

In the opposite direction, i.e. when the resilient element 22 expands, inflowing fluid can easily deform the lip seal 83. Thus, without damping, the resilient element 22 can expand.

Instead of lip seals 83, 85, other sealings may be used.

On the seat side 40a of the second valve body 40, two reflief grooves 86 have been formed. The relief grooves 86 prevent a build-up of large differential pressures across the closed second valve body 40 that would otherwise hinder the expansion of the resilient element 22.

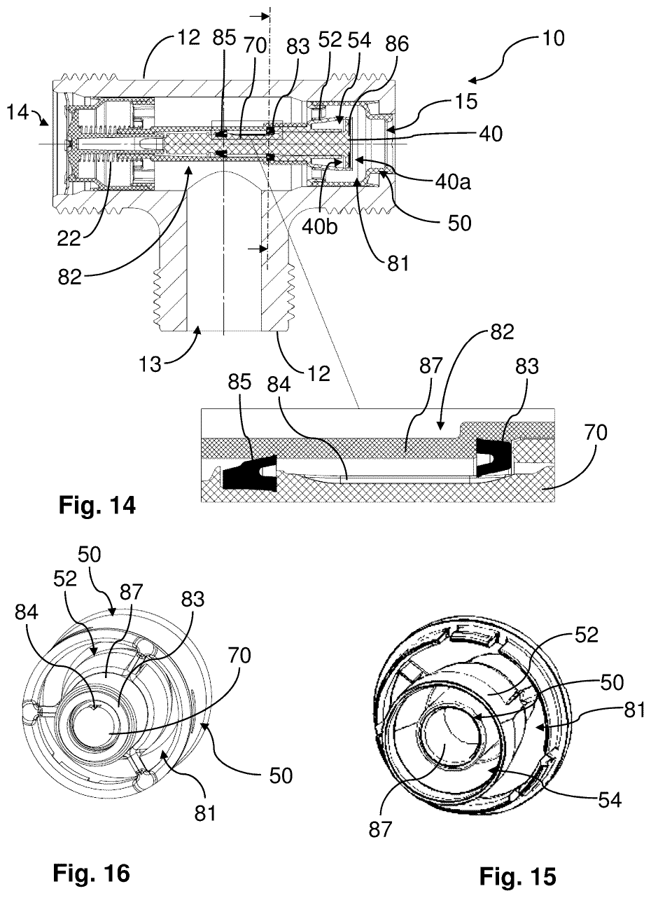

In FIG. 14 it is apparent that nearby the shield 52, a bottleneck 81 is form that accelerates passing fluid. This creates a low pressure side near the second valve body.

In order to not let too easily the second valve body 40 drag with the passing fluid, the second valve body, in its open position of FIG. 14, is completely covered by the shield as is spaced apart from said bottleneck 81.

After a certain movement of the valve stem 70 caused by fluid entering the second port 14, second valve member 40 will leave the receiving space 54. Only than the fluid passing the bottleneck will be able to drag along the second valve body 40 into its closed position.

The insert in FIG. 14 shows the damper 82 in more detail. The valve stem 70 is in a sliding arrangement inside a guiding element 87 which may be formed as a sleeve.

Between the guiding element 87 and the valve stem 70 there is a chamber 88 which is limited by the (first) lip seal 83 (or any other elastomeric element with sealing capabilities) and the (second) lip seal 85 (or any other elastomeric element with sealing capabilities). When the valve stem 70 slides inside the guiding element 87, the chamber 88 will get larger or smaller. As it is filled with water or any other preferably non-compressible fluid, the fluid will be pressed our or in during movement of the valve stem 70.

This is only possible because there is at least one bypassing passage, here as a bypassing groove 84, which lets the filling of the chamber 88 flow out and in, as is needed. If the pressure difference in the chamber is higher than outside of it, the lip seal 83 (or any other suitable sealing) will be pressed against the valve stem 70, thereby reducing the free cross section of the bypassing grove 84. This will result in more friction against a compression of the chamber 88.

FIG. 15 is a view on the receiving space 54 and the guiding element 87, where the valve stem 70 has been taken away. Outside the shield 52, and inside the second sleeve-shaped wall 50, the bottleneck 81 as described above is visible. In use, as is apparent from FIG. 14, the seat side 40a of the second valve body 40 sits inside the receiving space 54 and is covered sidewards by the projecting rim of the shield 52.

FIG. 16 shows a cut-away view of the arrangement of FIG. 14. The cross-section is taken at the dash dotted line of FIG. 14, with the direction of view as indicated by arrows. The V-shaped cross-section of the bypassing groove 84 is clearly visible. This shape is specifically adapted to cooperate with the lip seal 83 is the described manner.

It will be appreciated that the foregoing is presented by way of illustration only and not by way of any limitation. It is contemplated that various alternatives and modifications may be made to the described embodiments without departing from the spirit and scope of the invention. Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the ap-pended claims rather than by the foregoing description, and all alternate embodiments and changes to this embodiment which come within the meaning and range of equivalency of said claims are therefore to be embraced therein.

### LIST OF REFERENCE NUMERALS

10 valve arrangement
12 valve housing
13 first port
14 second port
15 third port
20 first valve body
20b stem side
20a seat side
22 resilient element
24 first seat insert
26 first valve seat
28 spring retainer
30 first sleeve-shaped wall
36 first socket
38 internal groove
40 second valve body
40a seat side
40b stem side
44 second seat insert
46 second valve seat
50 second sleeve-shaped wall
52 shield
54 receiving space
56 shoulder
58 fin
62 stem receiving sleeve
60 opening
66 second socket
68 internal groove
70 valve stem
72a first axial end
72b second axial end
74a projection
81 bottleneck
82 damper
83 lip seal
84 bypassing groove
85 lip seal
86 relief groove
87 guiding element
88 chamber
FR force
F₁ pressure force
F₂ force
F₃ force
F₄ force
W₁ width
W₂ width
X axial direction
X₁ axial dimension
X₂ axial dimension

1. A valve arrangement (10) configured to passively switch between first and second operational modes, the valve arrangement (10) comprising:
first (13), second (14), and third (15) ports;
a first valve body (20) biased by a resilient element (22) to a closed position against a first valve seat (26) of a first seat insert (24) which is located at or in proximity to the third port (15), in order to close the third port (15) in the first operational mode;
a second valve body (40) that acts against a second valve seat (46) of a second seat insert (44), which is located at or in proximity to the second port (14), and in the first operational mode, the second valve body (40) is in an open position spaced apart from the second valve seat (46) such that fluid is adapted to circulate from the first port (13) to the second port (14);
a valve stem (70) extending between the second valve body (40) and the first valve body (20) such that, in the first operational mode, movement of the first valve body (20) to the closed position moves the second valve body (40) to the open position, allowing circulation of the fluid between the first (13) and second (14) ports, and in the second operational mode, upon a force of the fluid acting on the first valve body (20) from the third port (15) overcoming a closing force of the resilient element (22) and any pressure force (F₁) of the fluid from the first (13) and/or second (14) ports, the first valve body (20) is movable to an open position while simultaneously moving the second valve body (40) to a closed position against the second valve seat (46) such that the fluid from the third port (15) is adapted to circulate through the first port (13);
a first sleeve-shaped wall (30) of the first seat insert (24) extends in an axial direction (X) and is configured to radially surround the first valve body (20) when the first valve body (20) is in the closed position;
a second sleeve-shaped wall (50) of the second seat insert (44) extends in the axial direction (X) and is configured to radially surround the second valve body (40) when the second valve body (40) is in the closed position;
wherein the first (20) and second (40) valve bodies and the valve stem

(70) are arranged such that as the first valve body (20) moves toward the open position, the first sleeve-shaped wall (30) axially overlaps a portion of the first valve body (20) until the second valve body (40) moves to a position, prior to reaching the closed position, where the second valve body (40) is at least partially overlapped by the second sleeve-shaped wall (50).

2. The valve arrangement (10) of claim 1, wherein the first (13), second (14), and third ports (15) are formed in a valve housing (12).

3. The valve arrangement (10) of claim 1, wherein the second valve body (40) has at least one relief groove (86) on a seat side (40a) thereof.

4. The valve arrangement (10) of claim 1, further comprising a damper (82) acts on the valve stem (70) to damp a motion that compresses the resilient element (22).

5. The valve arrangement (10) of claim 4, wherein the damper (82) applies a lesser damping to the valve stem (70) in a direction of expansion of the resilient element (22) than in a direction of compression of the resilient element (22).

6. The valve arrangement (10) of claim 4, wherein the or a damper (82) acting on the valve stem (70) comprises at least one elastomeric component and/or at least one bypassing passage formed in the valve stem (70).

7. The valve arrangement (10) of claim 4, wherein the damper (82) acting on the valve stem (70) comprises at least two lip seals (83, 85) opposing each other.

8. The valve arrangement (10) of claim 1, wherein upon the closing force of the resilient element (22) and the pressure force (F₁) from at least one of the first or second port (14) overcoming the force of the fluid at the third port (15), the valve arrangement (10) is configured to return to the first operational mode with the second valve body (40) being moved back toward the open position, and the second sleeve-shaped wall (50) axially overlaps a portion of the second valve body (40) until the first valve body (20) moves to a position, prior to reaching the closed position, where the first valve body (20) is at least partially overlapped by the first sleeve-shaped wall (30).

9. The valve arrangement (10) of claim 1, wherein at least one of the first or second valve bodies are cup-shaped and have an axially extending wall section that fits inside the respective first or second sleeve-shaped wall (50) with a clearance fit.

10. The valve arrangement (10) of claim 2, further comprising a shield (52) connected to the valve housing (12) in proximity to the second port (14), the shield (52) includes a receiving space (54) that faces a stem side (40b) of the second valve body (40), and in the first operational mode, with the second valve body (40) in the open position, the shield (52) surrounds a peripheral region of the second valve body (40).

11. The valve arrangement (10) of claim 10, wherein the shield (52) defines a bottleneck (81) for fluids flowing from the first port (13) and/or the third port (15) to the second port (14) and the second valve body (40), in the open position thereof, is spaced apart from the bottleneck (81) and/or is fully received withing the receiving space (54).

12. The valve arrangement (10) of claim 11, wherein the shield (52) is connected to the second seat insert (44).

13. The valve arrangement (10) of claim 11, wherein the second valve body (40) is cup-shaped and has an axially extending wall section that fits inside the second sleeve-shaped wall (50) with a clearance fit, and the shield (52) peripherally surrounds at least a portion of the axially extending wall section of the second valve body (40) in the first operating mode.

14. The valve arrangement (10) according to claim 11, wherein in the second operational mode, the second valve body (40) moves axially out from the receiving space (54) of the shield (52) such that fluid flow through the valve arrangement (10) acts on a stem side (40b) of the second valve body (40), applies a force on the second valve body (40) to assist in moving the second valve body (40) against the second valve seat (46).

15. The valve arrangement (10) according to claim 12, wherein the shield (52) is frusto-conical shaped, and is supported by one or more fins (58) that extend from at least one of the valve housing (12) or the second seat insert (44).

16. The valve arrangement (10) of claim 15, wherein the stem extends from the first valve body (20) through an opening (60) in the shield (52) to the second valve body (40).

17. The valve arrangement (10) of claim 16, further comprising a stem receiving sleeve (62) connected to the shield (52), and the opening (60) is defined through the stem receiving sleeve (62).

18. The valve arrangement (10) of claim 1, wherein the second valve body (40) includes a ramp section on a second valve seat (46) side (40a) thereof.

19. The valve arrangement (10) of claim 18, wherein the ramp section is frusto-conical, and when the valve arrangement (10) is in the first operational mode, a fluid flow through the valve arrangement (10) acts on the ramp section to apply an additional force on the second valve body (40) in the axial direction (X) toward the first valve body (20) that acts in addition to the force of the resilient element (22) to keep the first valve body (20) pressed in the closed position against the first valve seat (26).

20. The valve arrangement (10) of claim 1, wherein the valve stem (70) includes at least one projection (74a; 74b) at each of a first axial end (72a) and a second axial end (72b) thereof, and the first and second valve bodies each include a respective first (36) and second socket (66) connected to a respective stem side (20b; 40b) thereof that is configured to receive the respective first (72a) or second axial end (72b) of the stem, and the first (36) and second sockets (66) each include an internal groove (38; 68) in which the respective at least one projection (74a; 74b) is received with a snap fit.

21. The valve arrangement (10) of claim 20, wherein at least one of the internal grooves (38; 68) have a longer axial dimension (X₁; X₂) than an axial width (W₁; W₂) of the at least one projection (74a; 74b) received therein that allows an axial compensating movement.

22. The valve arrangement (10) of claim 20, wherein the at least one projection (74a; 74b) on each of the first (72a) and second axial ends (72b) of the stem is an annular protrusion.

23. The valve arrangement (10) of claim 20, wherein the first (72a) and second axial ends (72b) of the stem are tapered.

24. A valve arrangement (10) configured to passively switch between first and second operational modes, the valve arrangement (10) comprising:
first (13), second (14), and third ports (15);
a first valve body (20) biased by a resilient element (22) to a closed position against a first valve seat (26) of a first seat insert (24) which is located at or in proximity to the third port (15), in order to close the third port (15) in the first operational mode;
a second valve body (40) that acts against a second valve seat (46) of a second seat insert (44), which is located at or in proximity to the second port (14) and in the first operational mode, the second valve body (40) is in an open position spaced apart from the second valve seat (46) such that fluid is adapted to circulate from the first port (13) to the second port (14);
a valve stem (70) extending between the second valve body (40) and the first valve body (20) such that, in the first operational mode, movement of the first valve body (20) to the closed position moves the second valve body (40) to the open position, allowing circulation of the fluid between the first and second ports (14), and in the second operational mode, upon a force of the fluid acting on the first valve body (20) from the third port (15) overcoming a closing force of the resilient element (22) and any pressure force (F₁) of the fluid from the first and/or second ports (14), the first valve body (20) is movable to an open position while simultaneously moving the second valve body (40) to a closed position against the second valve seat (46) such that the fluid from the third port (15) is adapted to circulate through the first port (13); and
a shield (52) located in proximity to the second port (14), the shield (52) includes a receiving space (54) that faces a stem side (40b) of the second valve body (40), and in the first operational mode, with the second valve body (40) in the open position, the shield (52) surrounds a peripheral region of the second valve body (40).

25. The valve arrangement (10) of claim 24, wherein the first (13), second (14), and third ports (15) are formed in a valve housing (12).

26. The valve arrangement (10) of claim 24, wherein the shield (52) is connected to the second seat insert (44).

27. The valve arrangement (10) of claim 24, further comprising the second seat insert (44) having a second sleeve-shaped wall (50) that extends in an axial direction (X) and is configured to radially surround the second valve body (40) when the second valve body (40) is in the closed position, and the second valve body (40) is cup-shaped and has an axially extending wall section that fits inside the second sleeve-shaped wall (50) with a clearance fit, and the shield (52) peripherally surrounds at least a portion of the axially extending wall section of the second valve body (40) in the first operating mode.

28. The valve arrangement (10) of claim 24, wherein in the second operational mode, the second valve body (40) moves axially out from the receiving space (54) of the shield (52) such that fluid flow through the valve arrangement (10) acts on the stem side (40b) of the second valve body (40), applies a force on the second valve body (40) to assist in moving the second valve body (40) against the second valve seat (46).

29. The valve arrangement (10) of claim 24, wherein the shield (52) is frusto-conical shaped, and is supported by one or more fins (58) that extend from at least one of a valve housing (12) or the second seat insert (44).

30. A valve arrangement (10) configured to passively switch between first and second operational modes, the valve arrangement (10) comprising:
first (13), second (14), and third ports (15);
a first valve body (20) biased by a resilient element (22) to a closed position against a first valve seat (26) of a first seat insert (24) which is located at or in proximity to the third port (15), in order to close the third port (15) in the first operational mode;
a second valve body (40) that acts against a second valve seat (46) of a second seat insert (44), which is located at or in proximity to the second port (14), and in the first operational mode, the second valve body (40) is in an open position spaced apart from the second valve seat (46) such that fluid is adapted to circulate from the first port (13) to the second port (14);
a valve stem (70) extending between the second valve body (40) and the first valve body (20) such that, in the first operational mode, movement of the first valve body (20) to the closed position moves the second valve body (40) to the open position, allowing circulation of the fluid between the first (13) and second ports (14), and in the second operational mode, upon a force of the fluid acting on the first valve body (20) from the third port (15) overcoming a closing force of the resilient element (22) and any pressure force (F₁) of the fluid from the first (13) and/or second ports (14), the first valve body (20) is movable to an open position while simultaneously moving the second valve body (40) to a closed position against the second valve seat (46) such that the fluid from the third port (15) is adapted to circulate through the first port (13); and
the second valve body (40) includes a ramp section on a second valve seat (46) side (40a) thereof, wherein in the first operational mode a force (F₄) of the fluid flow through the valve arrangement (10) acts on the ramp section to apply an additional force in an axial direction (X) toward the first valve body (20).

31. The valve arrangement (10) of claim 30, wherein the ramp section is frusto-conical, and when the valve arrangement (10) is in the first operational mode, the fluid flow through the valve arrangement (10) acts on the ramp section to apply an additional force on the second valve body (40) in the axial direction (X) toward the first valve body (20) that acts in addition to the force of the resilient element (22) to keep the first valve body (20) pressed in the closed position against the first valve seat (26).

32. A passively switching valve arrangement (10), comprising:
first (13), second (14), and third (15) ports and defining at least two switching positions;
a damper (82) configured to damp a transition between the at least two switching positions, wherein in a first switching position of the at least two switching positions the valve arrangement is in a first operational mode, in which fluid is adapted to circulate from the first port to the second port, and in a second switching position of the at least two switching positions the valve arrangement is in a second operational mode, in which fluid from the third port is adapted to circulate through the first port.

33. The passively switching valve arrangement (10) of claim 32, further comprising a resilient element (22) that provides a restoring force defining a resting position of the at least two switching positions and the damper (82) acts against a compression of the resilient element (22).

34. A method of assembling a valve arrangement (10), the method comprising:
forming a first sub-assembly by assembling a first valve body (20) with a resilient element (22) in a first seat insert (24) that includes a first valve seat (26) and inserting a first axial end (72a) of a valve stem (70) with a snap fit into a first socket (36) on a stem side (20b) of the first valve body (20);
providing a valve housing (12) having first, second and third ports (13, 14, 15), and inserting the first sub-assembly stem first into the third port (15) of the valve housing (12);
forming a second sub-assembly by assembling a second valve body (40) with a second seat insert (44) that includes a second valve seat (46) and a shield (52) that partially surrounds the second valve body (40) in an open position of the second valve body (40);
inserting the second sub-assembly into the second port (14) of the valve housing (12) with a second axial end of the stem being received in a second socket (66) on the second valve body (40), with at least one of the stem or the second socket (66) extending through an opening (60) in the shield (52); and
connecting the second axial end (72b) of the stem with a snap fit into the second socket (66), such that the valve arrangement (10) is connected in the valve housing (12) with the valve stem (70) extending between the second valve body (40) and the first valve body (20) wherein, in a first operational mode, movement of the first valve body (20) to the closed position moves the second valve body (40) to the open position, allowing circulation of fluid between the first port (13) and the second port (14), and in a second operational mode, upon a force of the fluid acting on the first valve body (20) from the third port (15) overcoming a closing force of the resilient element (22) and any pressure force (F₁) of the fluid from the first (13) and/or second ports (14) the first valve body (20) is movable to an open position while simultaneously moving the second valve body (40) to a closed position against the second valve seat (46) such that the fluid from the third port (15) is adapted to circulate through the first port (13).
